(19) United States
(12) Patent Application Publication
(10) Pub. No.: US 2014/0015358 A1
(43) Pub. Date: Jan. 16, 2014

(54) INTEGRATED PHASE CONNECTION ISOLATOR WITH INDIVIDUAL PHASE ISOLATOR

(71) Applicant: Remy Technologies, LLC, Pendleton, IN (US)

(72) Inventors: Koon Hoong Wan, Fishers, IN (US); Bradley D. Chamberlin, Pendleton, IN (US)

(21) Appl. No.: 13/939,036

(22) Filed: Jul. 10, 2013

Related U.S. Application Data
(60) Provisional application No. 61/670,485, filed on Jul. 11, 2012.

(51) Int. Cl. H02K 3/34; H02K 15/02; H02K 3/46

(52) U.S. Cl. CPC H02K 3/345; H02K 3/46; H02K 15/02
USPC 310/71; 310/198; 29/596

(57) ABSTRACT

A stator assembly includes a coil isolator having a first flange, a phase separator, and a living hinge connecting the first flange and the phase separator, the coil isolator structured for enclosing a stator lamination stack and for winding a coil thereon in electrical isolation from the stack, the phase separator being radially closeable for enclosing a portion of the coil within the coil isolator. A method of forming a stator includes placing an isolator onto a lamination stack segment, winding a coil onto the isolator, folding a phase separator of the isolator to enclose a portion of the coil, and placing a plurality of bus bars onto the phase separator in physical partition from one another. A method of insulating a phase bus from a stator coil includes forming a coil insulator having a bobbin, a phase separator, and a living hinge coupling the bobbin to the phase separator.

### RELATED APPLICATIONS

This application claims the benefit of U.S. Patent Application Ser. No. 61/670,485 filed Jul. 11, 2012, which is incorporated herein by reference in its entirety.

### BACKGROUND

The subject invention relates to electric machines and, more particularly, to electric machines having a segmented stator.

There is an increasing demand for greater efficiency and improved power and torque densities in electric machines. Conventional electric machines often have a stator core formed by stacking laminations having inwardly projecting teeth that define slots between adjacent teeth. In many electric machines, e.g., brushless AC and DC electric machines, coils are wrapped around individual teeth so that the copper wire forming the coils fills the slots. When the stator core is a single structure forming a complete ring, access to the slots presents manufacturing difficulties which limit the density of the copper wire achievable within each of the slots. The density of the wires within the slots has a direct impact on the efficiency and on power and torque densities of the resulting electric machine, because higher fill factors provide enhanced performance characteristics.

One known method of increasing the slot fill factor of an electric machine is to use a segmented stator core. Instead of winding coils around the teeth of a unitary one piece stator core, segmented stator cores are manufactured by first forming individual stator teeth out of a stack of laminations. Wire coils are then wound about individual stator teeth. After winding of the coils is completed, the individual teeth with coils wound thereon are assembled into a ring and joined together to form the stator assembly. The ability to wind coils around individual stator teeth without any adjacent teeth inhibiting access during the winding process allows segmented stator cores to realize a higher slot fill density and the enhanced performance characteristics provided thereby.

Coil isolators are commonly used in segmented stator assemblies. Coil isolators may be overmolded onto the lamination stack or may be formed as a two-piece structure that is assembled over the top of the lamination stack. For example, coil isolators may be formed of thermally conductive, electrically insulating resin that prevents contact between the coil conductor and the lamination steel.

The interconnecting of phase and neutral leads extending from a plurality of individual coil winding assemblies of the stator of a rotating electrical device (e.g., a motor or generator), which are annularly arranged about the stator central axis, is often complicated and/or time consuming. In addition, the leads and/or their connections to one another or to other components should be isolated electrically to prevent shorting/grounding and should be mechanically stabilized to prevent movement of conductors. These design parameters are complicated in a multiple phase stator where several phases must be electrically isolated from one another.

A bus bar assembly or similar structure is often employed for faster, more reliable interconnecting of the various phase and neutral leads of multiple individual coil winding assemblies. However, a bus must be properly oriented, packaged and installed relative to the rest of the stator, preferably within the stator housing to protect it from externally-induced damage. In addition, when the bus assembly for multiple phases is at an axial end of a stator, a separate annular isolator may be required for isolating the buses from the individual coils, and such annular isolator typically requires alignment and reduces the space available for performing welding and connecting of the conductors.

### SUMMARY

It is therefore desirable to obviate the above-mentioned disadvantages by providing an integrated phase isolator that eliminates the need for an extra isolator, that removes a tensioning member, and that reduces costs and assembly time.

According to an exemplary embodiment, a stator assembly of an electric machine includes a coil isolator having a first flange, a phase separator, and a living hinge connecting the first flange and the phase separator, the coil isolator structured for enclosing a portion of a stator lamination stack and for winding a coil thereon in electrical isolation from the stack, the phase separator being radially closeable for enclosing a portion of the coil within the coil isolator.

According to another exemplary embodiment, a method of forming a stator includes placing an isolator onto a lamination stack segment, winding a coil onto the isolator, folding a phase separator of the isolator to enclose a portion of the coil, and placing a plurality of bus bars onto the phase separator in physical partition from one another.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein:

FIG. 1 is a schematic view of an electric machine;

FIG. 2 is a partial top plan view of a conventional segmented stator assembly;

FIG. 3 is a perspective view of a conventional lamination stack;

FIG. 4 is a top plan view of a lamination;

FIG. 5 is a perspective view of a conventional two-piece isolator;

FIG. 6 is a perspective view of a stator segment 70 having a lamination stack;

FIG. 7 is a perspective view of an exemplary segmented stator;

FIG. 8 is a sectional view of a portion of a bus assembly;

FIGS. 9A and 9B provide cross-sectional views of an isolator assembly 80 in respective open and closed positions;

FIG. 10 is a schematic view of a living hinge;

FIG. 11 is a cross-sectional view of an exemplary hinge portion formed as a series of individual living hinges;

FIG. 12 is a partial perspective view of an exemplary embodiment of a living hinge having a series of living hinge sections formed with an essentially constant width, serpentine-like structure;

FIG. 13 is a cross-sectional view of an isolator enclosing at least a portion of a lamination stack; and

FIGS. 14A and 14B are cross-sectional views respectively showing an isolator 141 in an open and closed position.

Corresponding reference characters indicate corresponding or similar parts throughout the several views.

### DETAILED DESCRIPTION

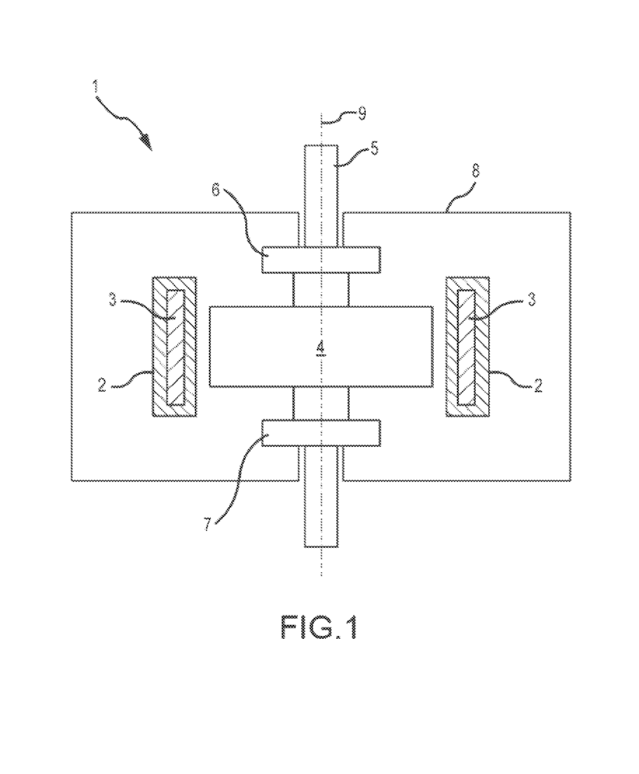

FIG. 1 is a schematic view of an exemplary electric machine 1 having a stator 2 that includes stator windings 3 such as one or more coils. An annular rotor body 4 may also contain windings and/or permanent magnets and/or conductor bars such as those formed by a die-casting process. Rotor body 4 is part of a rotor that includes an output shaft 5 supported by a front bearing assembly 6 and a rear bearing assembly 7. Bearing assemblies 6, 7 are secured to a housing 8. Typically, stator 2 and rotor body 4 are essentially cylindrical in shape and are concentric with a central longitudinal axis 9. Although rotor body 4 is shown radially inward of stator 2, rotor body 4 in various embodiments may alternatively be formed radially outward of stator 2. Electric machine 1 may be a motor/generator or other device. In an exemplary embodiment, electric machine 1 may be a traction motor for a hybrid or electric type vehicle. Housing 8 may have a plurality of longitudinally extending fins (not shown) formed to be spaced from one another on a housing external surface for dissipating heat produced in the stator windings 3.

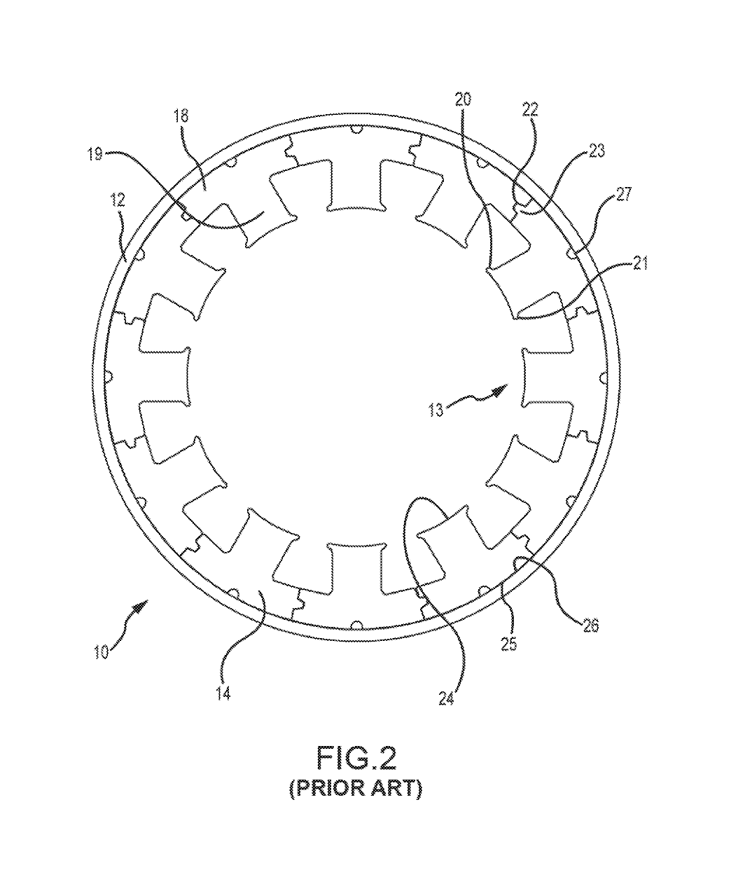

FIG. 2 is a partial top plan view of a conventional segmented stator assembly 10 that includes a housing 12 that encloses an outer circumference of a segmented stator 13. A rotor (not shown) is supported for rotation within stator core 13. Each stator core segment 14 may be formed as a solid core or as a stack of individual laminations, typically steel such as silicon steel coated with an electrical insulator. In the illustrated example, twelve stator core segments 14 are serially mated to form an annular stator. Each stator core segment 14 has a yoke portion 18 and a tooth shaped pole portion 19. The teeth 19 each have an arcuate inner edge surface 24 and circumferentially extending projections 20, 21. Yoke 18 has a circumferential tongue projection 23 extending axially on one circumferential end and has a circumferential groove 22 extending axially on the opposite circumferential end thereof. Stator core segments 14 are serially mated by placing the tongue 23 of a core segment 14 into the groove 22 of an adjacent core segment 14. The arcuate radially outward surfaces 25 of stator core segments 14 abut the annular inner surface 26 of housing 12, whereby housing 12 retains stator core segments 14 in an annular shape. The radially inward surfaces 24 of each respective tongue portion 19 are thereby aligned in a circle facing the rotor. The tongue and groove connections between stator core segments 14 allow easy assembly of segmented stator core 13.

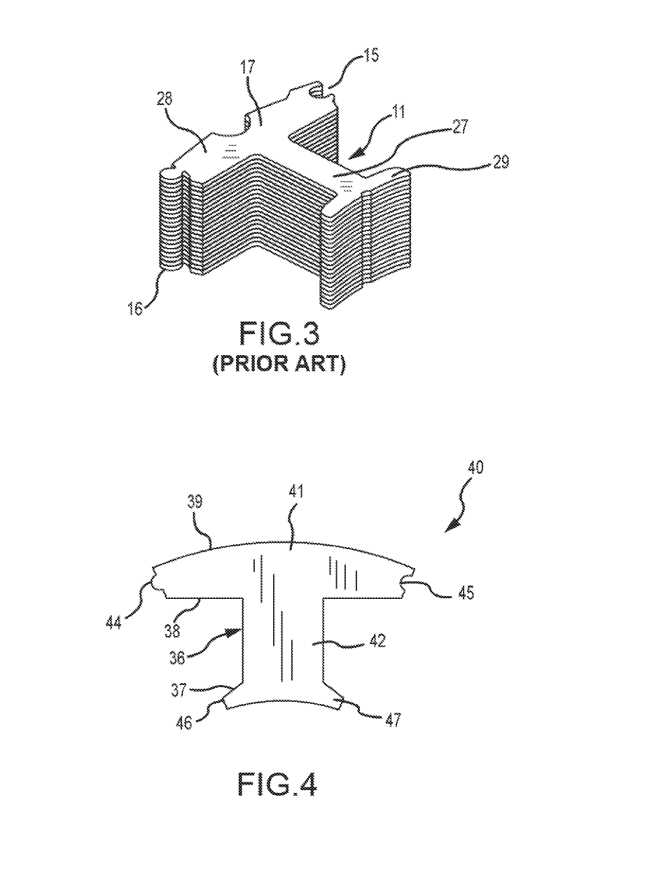

FIG. 3 is a perspective view of a conventional lamination stack 11 composed of identical individual laminations 17 formed of electrical steel or silicon steel and each having an electrically insulative coating. For example, lamination 17 may be punched from sheet steel having a thickness between 0.25 mm and 2.5 mm, or other. Laminations 17 each have a concave slot 15 and a corresponding convex tab projection 16. Lamination stack 11 is typically formed by aligning and fixing individual laminations 17 using a mold and an adhesive or other structure for bonding lamination stack 11 into an integrated stator segment core. Lamination stacks 11 may be serially connected by coupling concave slots 15 and convex tabs 16. Lamination stack 11 is roughly in the form of an “I” with a substantially flat center portion 27 connecting yoke portion 28 and tooth portion 29.

FIG. 4 is a top plan view of a lamination 40 that is stacked to form a stator core segment. Lamination 40 has a yoke portion 41, a center portion 42, and a tooth portion 43. Yoke 41 has a tongue 44 on one circumferential end and a groove 45 on the opposite circumferential end, whereby stator core segments may be serially joined together by insertion of a tongue 44 of a first stator core segment with a groove 45 of an adjacent stator core segment. Tooth 43 has extending portions 46, 47 at opposite circumferential ends thereof. When a series of stator core segments are joined together to form a complete stator, the arcuate outer surface 39 of laminations 40 are joined to form a circle that may be supported within a housing 12, by a band, or by other structure. A bobbin placement portion 36 is defined between a radially inward location 37, at the intersection of tooth 43 and center portion 42, and a radially outward location 38 at the flat portions of yoke 41.

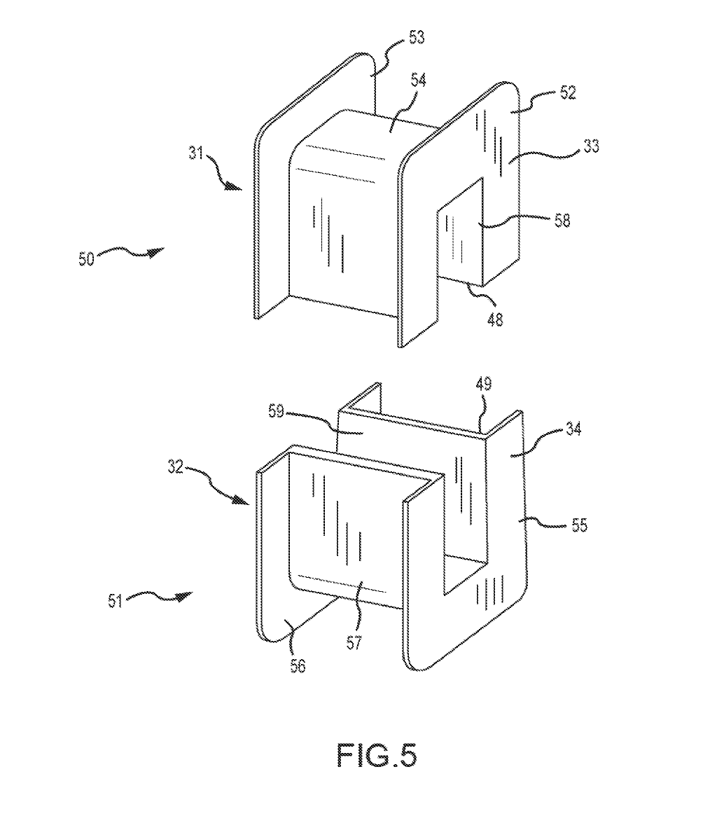

FIG. 5 is a perspective view of a conventional two-piece isolator. A top isolator piece 50 has a front flange 52, a rear flange 53, a wire winding portion 54, and an abutment surface 48. A bottom isolator piece 51 has a front flange 55, a rear flange 56, a wire winding portion 57, and an abutment surface 49. Respective center spaces 58, 59 and abutment surfaces 48, 49 of top and bottom isolation pieces 50, 51 are aligned with one another when top and bottom isolation pieces 50, 51 are joined together. Center spaces 58, 59 are thereby joined to create a volume having a width equal to or slightly greater than the width of center portion 42 of laminations 40 and having a height equal to or slightly greater than the height of the stacked laminations 40 that form the stator core segment. The depth of center spaces 58, 59 is substantially equal to the respective distances between outward facing sides of flanges 52, 53 and between outward facing sides of flanges 55, 56, and is also substantially equal to the distance between yoke 41 and tooth 43 of lamination 40. Flanges 53, 56 have respective radially outward faces 31, 32, and flanges 52, 55 have respective radially inward faces 33, 34.

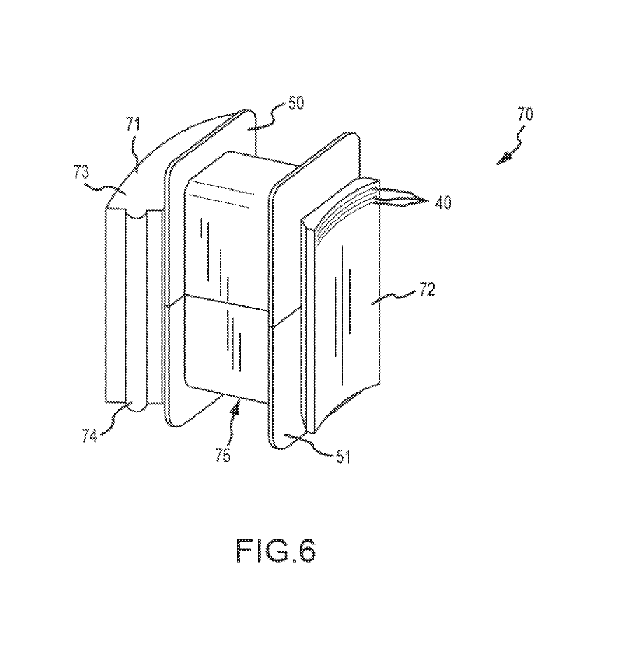

FIG. 6 is a perspective view of a stator segment 70 having a lamination stack 71 formed by stacking and aligning individual laminations 40. Typically, the construction of lamination stack 71 includes staking, adhering, fastening, and/or another method for maintaining structural integrity so that individual laminations 40 do not become loose or separate. When stator segment lamination stack 71 has been assembled with laminations 40, a thermally conductive material is placed into center spaces 58, 59 of top and bottom isolation pieces 50, 51, and isolation pieces 50, 51 are then pressed together to enclose center portions 42 of laminations 40 inside center spaces 58, 59. The structural assembly of isolation pieces 50, 51 around the stator segment lamination stack and the placement of thermally conductive material therebetween may be performed so that all air is removed from the portion of spaces 58, 59 between the stator segment lamination stack and isolation pieces 50, 51. The assembled top and bottom isolation pieces 50, 51 fit snugly between tooth portion 72 and yoke portion 73, and may be sealed thereto by the previously placed thermally conductive material, for example a silicon, nylon, epoxy, resin, carbon fiber, or other suitable substance. In particular, radially outward faces 31, 32 (e.g., FIG. 5) of flanges 53, 56 are in abutment with radially outward location 38 on the flat portion of yoke 41, and radially inward faces 33, 34 of flanges 52, 55 are in abutment with radially inward location 37 at the intersection of tooth 43 and center portion 42. When assembled, stator segment 70 forms a bobbin for winding a conductor coil in a wire winding space 75. The tongue 74 of stator yoke portion 73 fits into a corresponding groove of an adjacent stator segment.

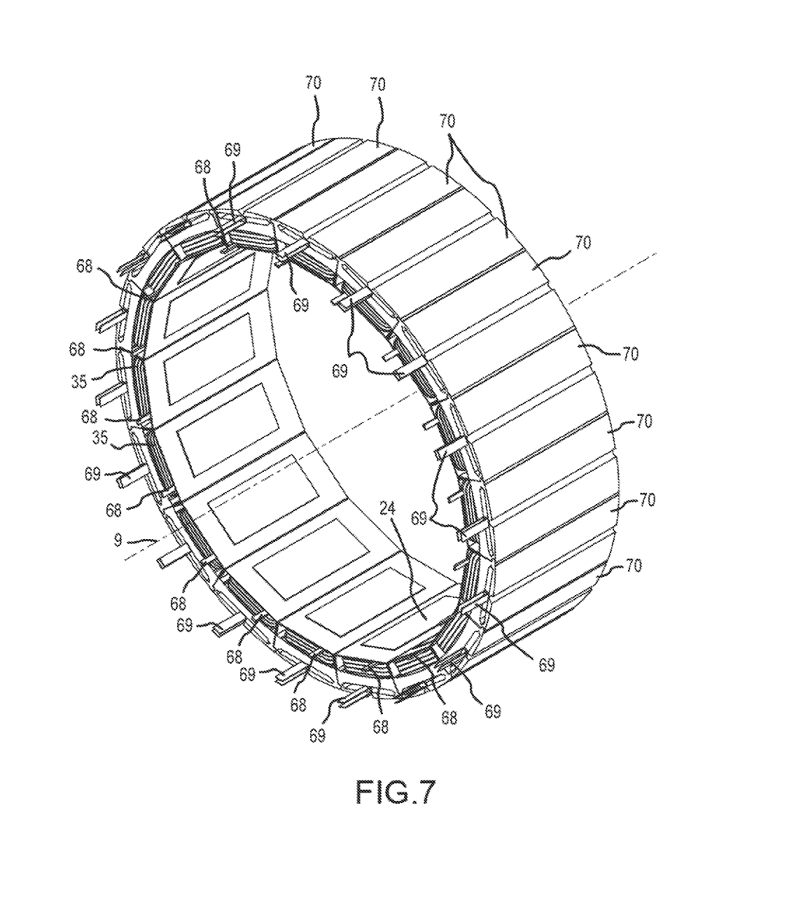

After stator segments 70 have been assembled, an insulated flat wire conductor, for example having a rectangular profile of 1 mm by 3 mm, is wound around each stator segment 70 a prescribed number of turns to form a coil 35. After being wound, coils 35 may be lacquered in a process that removes trapped air, whereby lacquered coils 35 have increased mechanical integrity. FIG. 7 is a perspective view of an exemplary segmented stator 30 having individual segments 70 joined together to form an annular shape about a center axis 9. Radially inward surfaces 24 of lamination stacks 71 face the center. Coils 35 each have a first coil end 68 and a second coil end 69. Coil ends 68, 69 extend axially at the same axial end of segmented stator 30 for subsequent connection to a wire bus assembly.

In an exemplary 3-phase electric machine 1 having a segmented stator 30, every third one of eighteen stator segments 70 is electrically connected at a respective coil end 69 by a bus. As a result, each of three phases A, B, and C have six coils 35 joined in parallel about axis 9. The eighteen coil ends 68 are joined together by a bus to form a neutral. The buses for neutral and phases A, B, C are each provided with a connection to external electrical equipment, for example a power supply (not shown).

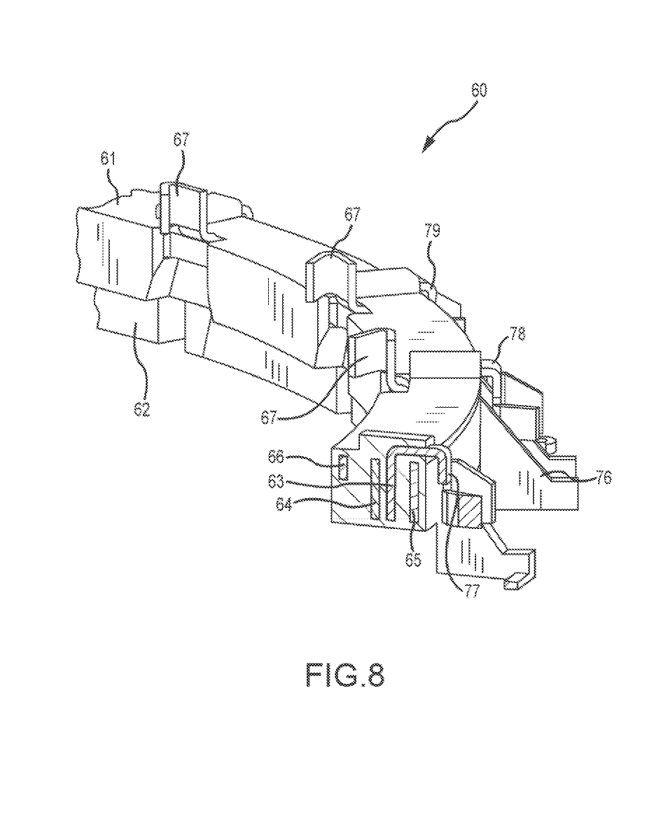

FIG. 8 is a sectional view of a portion of a bus assembly 60 formed of an annular lower tray 62 that fits onto an axial end of segmented stator 30, an annular phase A bus bar 63, an annular phase B bus bar 64, an annular phase C bus bar 65, an annular neutral bus bar 66, and a top cover 61. Neutral bus 66 is electrically connected to terminal posts 67 that protrude through top cover 61 for connection to the eighteen first coil ends 68 by crimping and/or welding. Similarly, phase A bus bar 63 has six connection terminals 77 for electrical connection to six phase A coil ends 69, phase B bus bar 64 has six connection terminals 78 for electrical connection to six phase B coil ends 69, and phase C bus bar 65 has six connection terminals 79 for electrical connection to six phase C coil ends 69. Any of terminals 67, 77, 78, 79 may also be utilized for electrical connection to external equipment. Lower tray 62 includes support structure 76 for securing bus assembly 60 to housing 12 or other structure of electric machine 1.

Bus assembly 60 separately joins together the respective coils 35 for each phase of phases A, B, C and joins the coil ends 68 to a neutral bus 66 while electrically isolating each of these common buses from one another and from contact with lamination stacks 71. In certain packaging and envelope designs, it may be required to join coil ends 68, 69 and external connections to buses 63-66 with terminals axially outward of buses 63-66. In such a case, coil ends 68, 69 and external terminals 67, 77-79 may be required to fit within a same space as buses 63-66. These and other requirements may be met by adapting structure such as that of bus assembly 60. However, the various trays and bus assemblies add to the number of components, to the number of connections, and to space requirements in a phase separator portion. As a result, the costs of labor, parts, and associated overhead is high and design requirements are limited by space considerations.

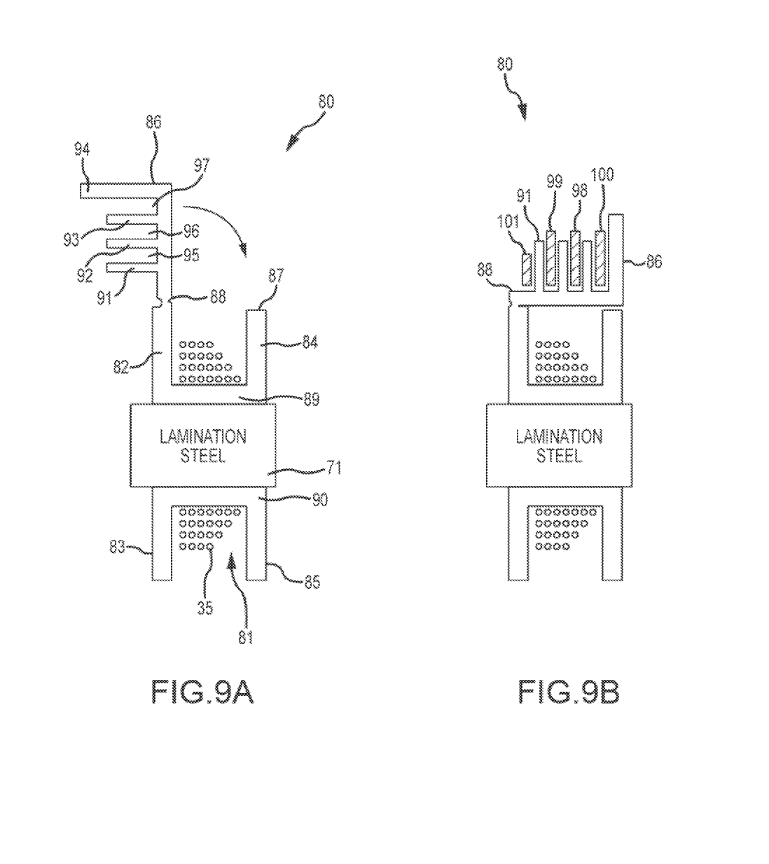

FIGS. 9A and 9B provide cross-sectional views of an exemplary embodiment of an isolator assembly 80 in respective open and closed positions. Isolator 80 may be formed as any number of individual pieces, and is shown by example as a unitary device having a top isolator portion 89 and a lower isolator portion 90 that are joined together to enclose the central portion of lamination stack 71. The open position of FIG. 9A provides a wire winding space 81 between flange portions 82, 83 and flange portions 84, 85 for winding a coil 35 within a phase isolator. After coil 35 is wound, associated coil ends 68, 69 are positioned, and wound coil 35 is varnished. A phase separator 86 is then folded down into abutment with flange end surface 87. A living hinge 88 is formed as an integral portion of a top isolator portion 89 and allows a designer to optimize criteria and variables related to hinging, as discussed herein. Phase separator 86 has extending portions 91-94 arranged to form respective bus channels 95-97 therebetween. In the closed position shown by example in FIG. 9B, living hinge 88 is deformed in a manner that distributes bending force so that post-bend stress on hinge 88 is distributed and/or minimized. Bus bars 98, 99, 100 are respectively placed into channels 96, 95, 97 for electrical connection as phases A, B, C. A neutral bus bar 101 may optionally be placed adjacent extending portion 91.

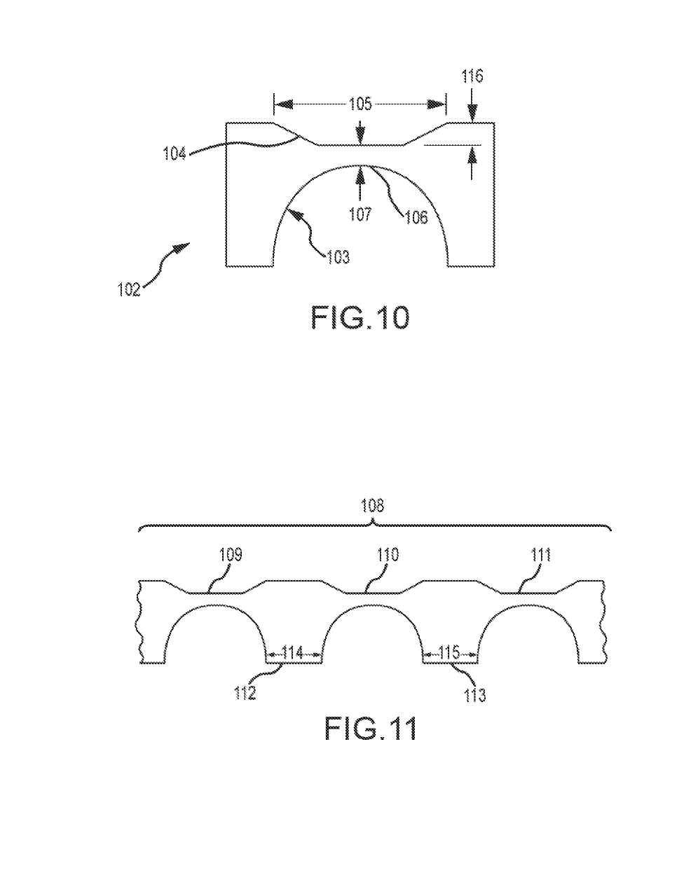

Living hinge 88 may be formed as a single hinge section 102 as shown by example in FIG. 10, or it may be formed as a series of hinge sections as shown by example in FIG. 11. By implementing living hinge 88 as a series of hinge sections 102, the angular displacement occurring between an open and a closed state of phase separator 86 is thereby distributed among the plurality of individual hinge sections 102. By distributing the stress and strain among a plurality of living hinge sections 102, a thicker material may be used and elasticity is obtained as an aggregate of bendability of the series of hinge sections, and an elastic region of living hinge 88 may be optimized. Individual hinge sections 102 are thereby not strained beyond a point where permanent deformation of the plastic can occur, and the plastic, or other material, will recover its shape after a flex and have a longer life. For example, although a use may primarily pertain to a single bend into a closed position shown in FIG. 9B, a living hinge 88 may better withstand handling and manufacturing, and may have improved reliability with an optimized construction.

Hinge section 102 has a hinge radius 103 that helps orient the polymer molecules and also determines how a bending force is distributed when folding occurs. Molecular orientation provides hinge 102 with strength and a long life. A land 104 having a land length 105 is formed on a side of living hinge 102 opposite hinge radius 103 for further reducing a possibility of cracking and undue concentration of stress, for preventing notching, and for providing a smoother hinging action when living hinge 102 is folded. A bending portion 106 of living hinge 102 has a hinge thickness 107 at a minimum width location.

FIG. 11 is a cross-sectional view of an exemplary hinge portion 108 formed as a series of individual living hinges each having individual parameters described generically for living hinge 102 of FIG. 10. A “series” describes an adjacent plurality of living hinges formed to have longitudinal rib sections between each living hinge section 102. In the FIG. 11 example, adjacent living hinges 109, 110, 111 are separated from one another by ribs/ridges 112, 113. In a given series of adjacent living hinges 109-111, for example, a width of ridge 112 may be one-half to four times a corresponding hinge radius 103, depending on the material used, the hinge thicknesses 107, and depending on the number of living hinge sections 102 in the given hinge portion, etc. A width 114 of rib 112 may be the same as a width 115 of rib 113, or the widths 114, 115 may be varied to account for different stress vectors that occur when folding and unfolding hinge section 108.

Similarly, living hinges 109-111 may be formed with identical dimensions (described generically with reference to FIG. 10), or such dimensions may be varied to optimize a distribution of stress and strain, such as for achieving a long hinge life or for achieving a large angular displacement. For example, increasing a hinge width 107 of living hinge 109 to be larger than hinge widths of living hinges 110, 111 acts to transfer a certain amount of bending force to hinges 110, 111, thereby spreading out or distributing such bending force. Relative locations of radii 103 of living hinges 109-111 and a bend volume relationship between such living hinges may vary according to a number of living hinges being used in hinge section 108, the size and weight of phase separator 86, and according to other factors such as ambient temperature specifications of the plastic material. Dimensions of rib widths 114, 115, living hinge recesses 109-111, and related thicknesses may be specified according to calculations of vector components, material properties, anticipated velocities of movement, aging requirements, ease of bending, number of longitudinal ribs, mass, and by considering other parameters.

For example, when determining relative dimensions for a series of living hinges 109-111 and the corresponding rib widths 114, 115 therebetween, a designer may first determine a range of travel for the plurality of living hinges, individually, or for phase separator 86 relative to flange 82 (FIG. 9A). Next, the designer may select a desired force distribution profile for the range of travel based on the individual application. For example, a hinge section 108 formed of a given thickness may have a stiffer action when the number of hinge sections is less, the thicknesses of materials are greater, etc. In such a case, altering rib widths 114, 115 may provide an easier relative hinging action by transferring force more efficiently. Similarly, changing a radius 103 of individual living hinges in order to achieve a desired ease of hinging movement may result in a tradeoff result of a slightly lower hinge lifetime. In another example, when the desired force distribution profile has been determined for the hinge section 108 and its series of living hinges, the designer may choose to implement such profile for the series of living hinges by selecting dimensions according to ratios/interrelations between width(s) 114, 115 of given elongate rib(s), minimum thickness(es) 107 of the bending portion(s) 106 of corresponding adjacent living hinges 109-111, radi(i) 103 of given living hinges, length(s) 105 and/or depth(s) 116 of land(s) 104 of given living hinge(s), etc. Such interrelated dimensioning may be defined according to a relational database for degrees of freedom corresponding to the variables at the designer's disposal. Different patterns may be used to filter such a database, for example as a homogenous series where each individual living hinge of the series has the same dimensions, as a progressive series where chosen dimensions increase/decrease for adjacent living hinges of a series according to a curve (e.g., linear, non-linear, exponential, etc.), such as a cold/hot temperature series where dimensions and material composition are optimized for resistance to cracking, and as any other series including, but not limited to, respective combinations of a series' different profile definitions, such as a deflection range, spring rate, and/or material elasticity. One skilled in the art will easily determine additional patterns and modifications to be implemented in a series of living hinges.

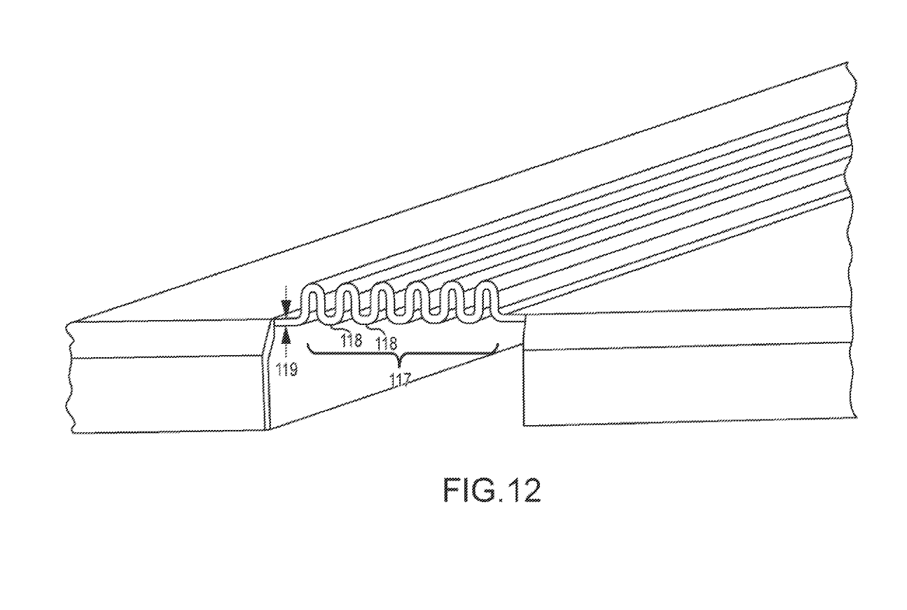

FIG. 12 is a partial perspective view of an exemplary embodiment of a living hinge 88 having a series 117 of living hinge sections 118 formed with an essentially constant width, serpentine-like structure. That is, a wall thickness 119 is maintained at a same thickness throughout the series 117 of living hinge sections 118. In an exemplary embodiment, thickness 119 may be determined by using 0.6 mm material and then drawing down (stretching) the material to achieve a final thickness 119 of approximately 0.4 mm. Various known methods may be employed for controlling dimensional tolerancing. A designer's choice for thickness 119 may be based on considerations of cost because a thicker product typically has a higher unit cost. Series 117 may be formed in serpentine fashion as continuous “S” type hinges 118 each having the same profile and dimensions but, similar to the case of hinge portion 108 (FIG. 11), living hinge series 117 may alternatively be comprised of individual hinges with varying dimensions. In addition, a thickness 119 may have a profile chosen to allow living hinge series 117 to be expandable laterally. For example, when living hinge 88 is formed with a smaller thickness 119 and an expanded, less tightly compressed living hinge series 117, a phase separator 86 may be placed so that it lies flat against coil 35. In another exemplary embodiment, a living hinge 88 may be formed as an arcuate or other non-linear structure so that phase separator 86 may be hinged along a circumferential surface. In addition, S-hinges 118 may be selectively spaced apart or be placed according to a varying width, etc. Hinges typically have a memory and a certain amount of “spring-back,” so that a chosen profile for a living hinge series 117 may account for resistance to and/or diminishing of such hinge properties. Generally, the greater the number of individual hinges in a hinge series 117, the easier the given hinge section 117 may be adapted for folding.

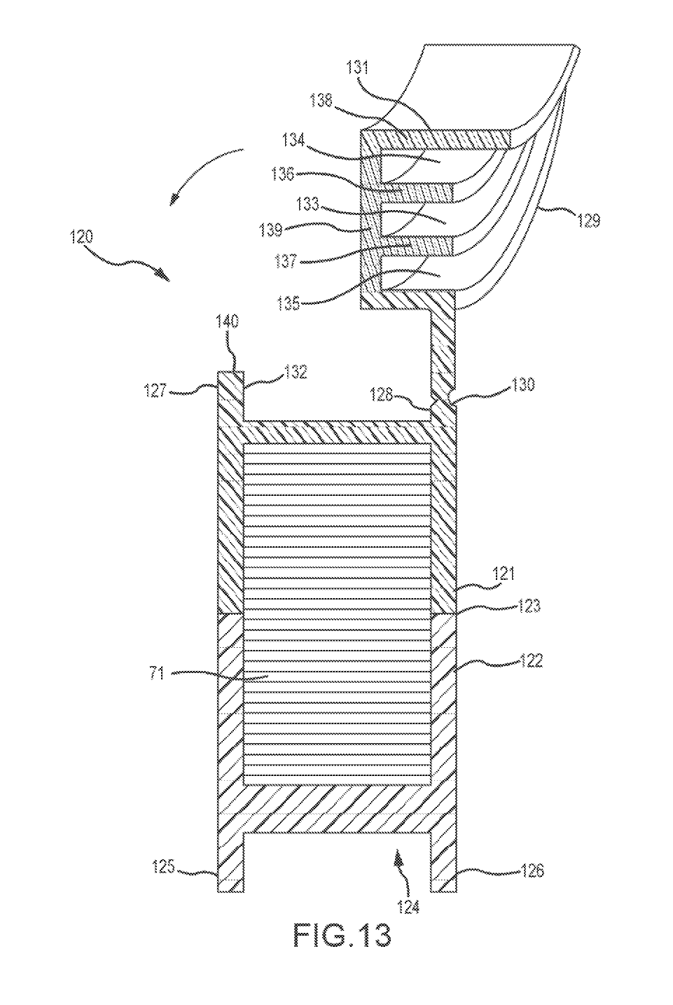

FIG. 13 is a cross-sectional view of an isolator 120 having an upper section 121 and a lower section 122 secured to one another at a joint 123 and enclosing at least a portion of a lamination stack 71. Joint 123 may be any appropriate attachment structure including, but not limited to, tongue and groove, overlapping, pin and receptacle, latch, adhesive, alignment tabs, and others. A coil winding space 124 is formed between respective flanges 125, 127 and flanges 126, 128. A phase separator 129 is integrally formed at the top of flange 128 and is joined thereto by living hinge 130. For example, living hinge 130 may be a single living hinge section 102, a series of living hinges 108, or an S-hinge series 117, as described herein. After a coil 35 has been wound onto winding space 124 and lacquered and dressed, phase separator 129 is folded down to a closed position (not shown), whereby a radially inner edge 131 of phase separator 129 snugly fits against an inner edge 132 of flange 127. In this closed position, A, B, and C buses 98-100 may be placed into respective bus slots 133-135. Slots 133, 134 are separated by partition 136 and slots 134, 135 are separated by partition 137. For example, when flanges 127, 128 are curved, living hinge 130 may have a series of hinges adapted to such curve by having various widths and thicknesses as described herein. The radially inner wall 138 may be secured to flange 127 by appropriate attachment structure including, but not limited to, tongue and groove, overlapping, pin and receptacle, latch, adhesive, alignment tabs, and others. The tray portion 139 of phase separator 129 may be formed to fit on top of a coil 35 located in winding space 124, and may include holes (not shown) for the passage of potting material or electrical connections between a coil 35 and a bus bar. A neutral bus (not shown) may optionally be placed along an end 140 of flange 127, or in another appropriate location. Alternatively, an additional slot and corresponding partition may be formed in phase separator for a neutral bus 101 (FIG. 9B). In a closed position, phase separator 129 provides phase isolation for radially-separated annular bus bars.

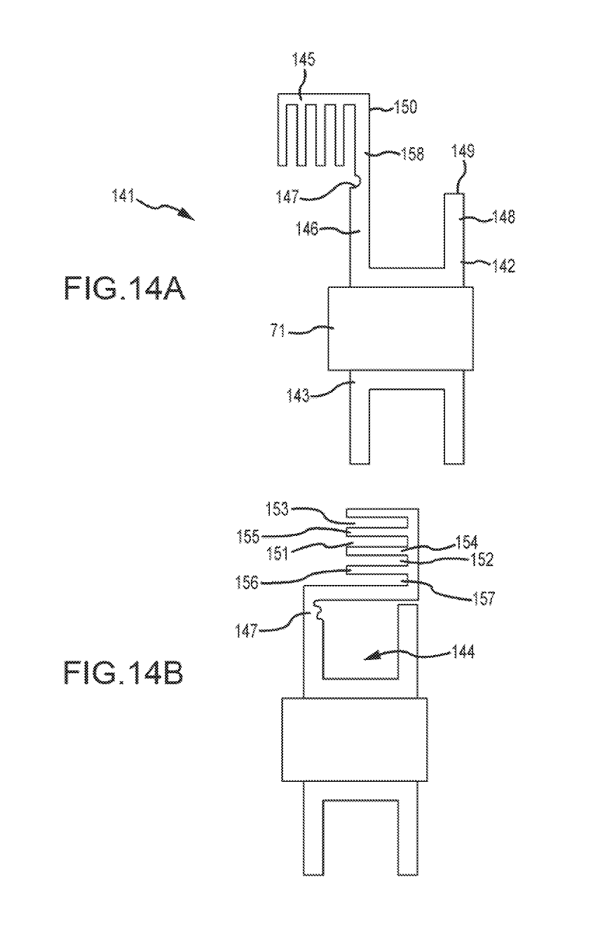

FIGS. 14A and 14B are cross-sectional views respectively showing an isolator 141 in an open and closed position. Isolator 141 has a top section 142 and a bottom section 143 that are joined together to enclose at least a portion of lamination stack 71. After sections 142, 143 are joined to enclose the portion of lamination stack 71, a coil 35 (FIG. 9A) is wound in coil winding space 144 and lacquered. An integrally formed phase separator 145 is joined to flange 146 by living hinge 147. Flange 148 of upper section 142 has an end surface 149 that contacts an abutment surface 150 of phase separator 145 when phase separator 145 is folded into the closed position. In such closed position, phase separator 145 has horizontally oriented and radially extending bus slots 151, 152, 153 respectively separated by partitions 154, 155 and structured for receiving respective A, B, and C phase bus bars (not shown). Such bus bars may be formed substantially as rings and similar to bus bars 98-100 except having a horizontally extending cross-sectional profile rather than a vertical one. In addition, a partition 156 provides a neutral bus slot 157 adjacent extending member 158. Isolator 141 thereby provides phase isolation for axially-separated annular bus bars.

The various isolators and sections thereof may be formed of any suitable high temperature material such as electrically insulative, thermally conductive resin, carbon fiber, nylon composite, and others known in the art. By providing a unitary structure for isolating coil windings from contact with conductive surfaces such as those of a lamination stack and for separating and thereby isolating phase bus structures from one another, the exemplary isolator embodiments provide a simplified multiple purpose apparatus and manufacturing method for an electric machine 1. Any of the disclosed features and methods of various embodiments may be used and substituted for similar elements of other embodiments. For example, the various configurations for a living hinge may be adapted for a given implementation. In addition, manufacturing steps such as varnishing, potting, and thermal control (e.g., injection of thermally conductive material) may be performed after an isolator is in a closed position by forming injection holes to access a coil winding space. In such a case, bus bars may be placed into their final positions in a phase separator portion prior to the varnishing or other process step, thereby saving additional manufacturing time and expense.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. A stator assembly of an electric machine, comprising a coil isolator having a first flange, a phase separator, and a living hinge connecting the first flange and the phase separator, wherein the coil isolator is structured for enclosing a portion of a stator lamination stack and for winding a coil thereon in electrical isolation from the stack, the phase separator being radially closeable for enclosing a portion of the coil within the coil isolator.

2. The stator assembly of claim 1, further comprising a latch structured for securing the phase separator in a closed position.

3. The stator assembly of claim 1, wherein the living hinge is formed as a series of individual living hinges.

4. The stator assembly of claim 3, wherein respective dimensions of the individual living hinges vary according to a force distribution profile for the series.

5. The stator assembly of claim 4, wherein the force distribution profile is based on temperature-related properties of hinge materials.

6. The stator assembly of claim 4, wherein the force distribution profile is based on at least one of deflection range, spring rate, and material elasticity.

7. The stator assembly of claim 1, wherein the coil isolator has a second flange, and wherein the phase separator, in a closed position, couples the first and second flanges.

8. The stator assembly of claim 7, wherein the phase separator is radially contained between the first and second flange in the closed position.

9. The stator assembly of claim 1, further comprising a plurality of arcuate bus conductors, wherein the phase separator has at least one partition structured for physically separating ones of the plurality of bus conductors.

10. The stator assembly of claim 9, wherein the at least one partition extends substantially axially when the phase separator is in a closed position.

11. The stator assembly of claim 9, wherein the stator assembly has a center axis and wherein the at least one partition is substantially orthogonal to the axis when the phase separator is in a closed position.

12. A method of forming a stator, comprising:
placing an isolator onto a lamination stack segment;
winding a coil onto the isolator;
folding a phase separator of the isolator to thereby enclose a portion of the coil; and
placing a plurality of bus bars onto the phase separator in physical partition from one another.

13. The method of claim 12, further comprising varnishing the wound coil.

14. The method of claim 12, further comprising latching the phase separator into a final position.

15. The method of claim 12, wherein the phase separator is joined to a remaining portion of the isolator by a series of living hinges, the method further comprising dimensioning individual living hinges of the series according to a force distribution profile.

16. The method of claim 15, wherein the force distribution profile is based on temperature-related properties of hinge materials.

17. The method of claim 12, wherein the folding rotates the phase separator by approximately ninety degrees about a living hinge.

18. The method of claim 12, further comprising feeding an end of the coil through the phase separator.

19. The method of claim 18, further comprising mating the coil end to one of the bus bars.

20. A method of insulating at least one phase bus from a coil of a stator, comprising forming a coil insulator having a bobbin, a phase separator, and a living hinge coupling the bobbin to the phase separator.
